(19) United States
(12) Patent Application Publication
(10) Pub. No.: US 2006/0119269 A1
(43) Pub. Date: Jun. 8, 2006

(54) Plasma display panel

(75) Inventor: Yu Park, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/288,340

(22) Filed: Nov. 29, 2005

(30) Foreign Application Priority Data
Dec. 7, 2004 (KR) 10-2004-0102690

(51) Int. Cl. H01J 17/49

(52) U.S. Cl. 313/582

(57) ABSTRACT

The present invention relates to a plasma display panel, and more particularly, to the structure of a plasma display panel. The plasma display panel according to the present invention has a optical characteristic improvement material included in any one of an upper dielectric layer, a protection film and an upper substrate. As a result, in accordance with the present invention, a optical characteristic improvement film can be obviated from the front filter, the plasma display panel can be made thin and the manufacturing cost can be saved.

This Nonprovisional application claims priority under 35 U.S.C. §119(a) on Patent Application No. 10-2004-0102690 filed in Korea on Dec. 7, 2004, the entire contents of which are hereby incorporated by reference.

### BACKGROUND OF THE INVENTION

1. Field of the Invention

The present invention relates to a plasma display panel, and more particularly, to the structure of a plasma display panel.

2. Description of the Background Art

In general, in a plasma display panel, a barrier rib formed between an upper panel and a lower panel forms one unit cell. Each cell is filled with an inert gas comprising a primary discharge gas, such as neon (Ne), helium (He) or a mixed gas of Ne+He, and a small amount of xenon (Xe). If the inert gas is discharged with a high frequency voltage, it generates vacuum ultraviolet rays. Phosphors formed between the barrier ribs are excited to implement images.

More particularly, a three-electrode AC surface discharge type plasma display panel has advantages of lower voltage driving and longer product lifespan since wall charges are accumulated on a surface upon discharge and electrodes are protected from sputtering generated by a discharge.

FIG. 1 illustrates the structure of a plasma display panel in the related art.

Referring to FIG. 1, the discharge cell of the plasma display panel in the related art comprises scan electrodes Y and sustain electrodes Z formed on a bottom surface of an upper substrate 10, and address electrodes X formed on a lower substrate 18. The scan electrode Y comprises a transparent electrode 12Y, and a metal bus electrode 13Y, which has a line width smaller than that of the transparent electrode 12Y and is disposed at one side edge of the transparent electrode. Furthermore, the sustain electrode Z comprises a transparent electrode 12Z, and a metal bus electrode 13Z, which has a line width smaller than that of the transparent electrode 12Z and is disposed at one side edge of the transparent electrode.

The transparent electrodes 12Y, 12Z are generally formed of Indium Tin Oxide (ITO) and are formed on a bottom surface of the upper substrate 10. The metal bus electrodes 13Y, 13Z are generally formed of metal such as chromium (Cr) and are formed on the transparent electrodes 12Y, 12Z. The metal bus electrodes 13Y, 13Z serve to reduce a voltage drop caused by the transparent electrodes 12Y, 12Z having high resistance. On the bottom surface of the upper substrate 10 in which the scan electrodes Y and the sustain electrodes Z are formed parallel to each other is laminated an upper dielectric layer 14 and a protection layer 16. Wall charges generated during the discharge of plasma are accumulated on the upper dielectric layer 14. The protection layer 16 functions to prevent the upper dielectric layer 14 from being damaged by sputtering generated during the discharge of plasma and also to improve emission efficiency of secondary electrons. Magnesium oxide (MgO) is generally used as the protection layer 16.

A lower dielectric layer 22 and barrier ribs 24 are formed on the lower substrate 18 in which the address electrodes X are formed. A phosphor layer 26 is coated on the surfaces of the lower dielectric layer 22 and the barrier ribs 24. The address electrodes X are formed to cross the scan electrodes Y and the sustain electrodes Z. The barrier ribs 24 are formed parallel to the address electrodes X and function to prevent ultraviolet generated by a discharge and a visible ray from leaking to neighboring discharge cells. The phosphor layer 26 is excited with an ultraviolet generated during the discharge of plasma to generate any one visible ray of red, green and blue. An inert mixed gas is injected into discharge spaces provided between the upper substrate 10 and the barrier ribs 24 and between the lower substrate 18 and the barrier ribs 24.

FIG. 2 illustrates a method of implementing images of the plasma display panel in the related art.

As shown in FIG. 2, in the plasma display panel, one frame period is divided into a plurality of sub-fields having a different number of discharges. The plasma display panel is excited in a sub-field period corresponding to a gray level value of an input image signal, thereby implementing images.

Each sub-field is divided into a reset period for uniformly generating a discharge, an address period for selecting a discharge cell and a sustain period for implementing gray levels depending on the number of discharges. For example, if it is sought to display images with 256 gray levels, a frame period (16.67 ms) corresponding to 1/60 seconds is divided into eight sub-fields, as shown in FIG. 2.

Each of the eight sub-fields SF1 to SF8 is again divided into a reset period, an address period and a sustain period. In this case, the sustain period increases in the ratio of 2n (where, n=0,1,2,3,4,5,6,7) in each sub-field. As described above, since the sustain period is varied in each sub-field, gray levels of images can be represented.

In the plasma display panel driven as described above, a versatile front filter is disposed on the upper substrate 10. In the related art, the front filter has been used in order to accomplish objects, such as Electromagnetic Interference (hereinafter referred to as “EMI”) shielding, Near Infrared Rays (hereinafter referred to as “NIR”) shielding, improved color purity and prevention of the reflection of external light. Since the front filter in the related art consists of a number of layers, however, a problem arises because the front filter has a predetermined or higher thickness. More particularly, the optical characteristic improvement film included in the front filter is difficult to form using only a optical characteristic improvement material. Therefore, there are problems in that the process time is long and the manufacturing cost is high.

### SUMMARY OF THE INVENTION

Accordingly, an object of the present invention is to solve at least the problems and disadvantages of the background art.

It is an object of the present invention to provide a plasma display panel in which the manufacturing cost can be saved and the manufacturing process can be reduced.

It is another object of the present invention to provide a plasma display panel in which it can facilitate thinning.

It is another object of the present invention to provide a plasma display panel in which a optical characteristic can be improved.

A plasma display panel according to an aspect of the present invention comprises an upper substrate and a lower substrate that are connected with a predetermined distance therebetween, and an upper dielectric layer comprising a optical characteristic improvement material that is formed on the upper substrate.

A plasma display panel according to another aspect of the present invention comprises an upper substrate and a lower substrate that are connected with a predetermined distance therebetween, an upper dielectric layer formed on the upper substrate, and a protection film comprising a optical characteristic improvement material that is formed on the upper dielectric layer.

A plasma display panel according to still another aspect of the present invention comprises an upper substrate comprising a optical characteristic improvement material; and a low substrate connected with the upper substrate with a predetermined distance therebetween.

The present invention is advantageous in that it can save the manufacturing cost and can reduce the manufacturing process.

The present invention is advantageous in that it can facilitate the thinning of a plasma display panel.

The present invention is advantageous in that it can improve a optical characteristic.

### BRIEF DESCRIPTION OF THE DRAWINGS

The invention will be described in detail with reference to the following drawings in which like numerals refer to like elements.

FIG. 1 illustrates the structure of a plasma display panel in the related art;

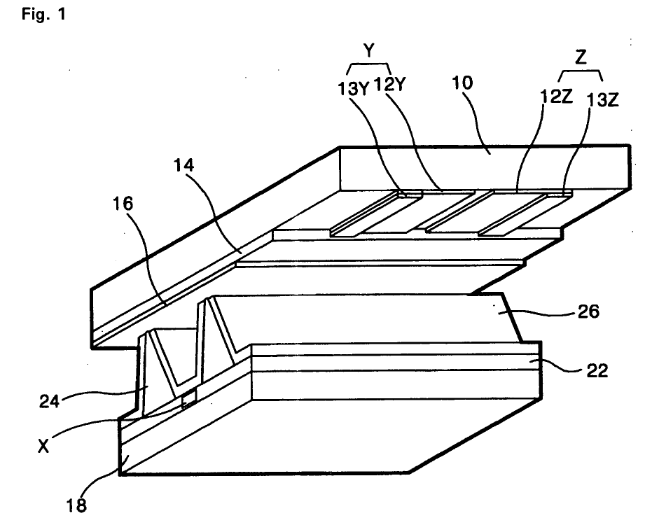

FIG. 2 illustrates a method of implementing images of the plasma display panel in the related art;

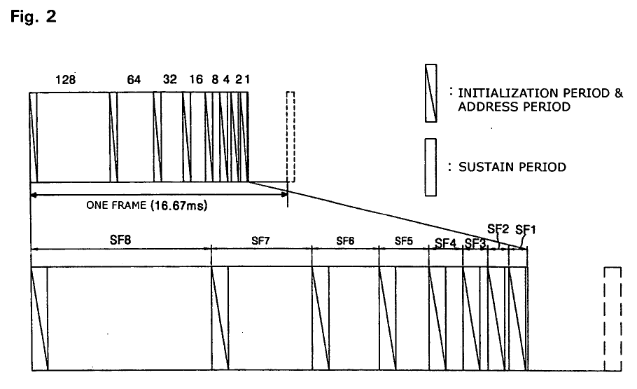

FIG. 3 is a perspective plan view representing a plasma display panel according to an embodiment of the present invention;

FIG. 4 is a cross sectional diagram representing a front filter shown in FIG. 3 according to an embodiment of the present invention;

FIG. 5 is a diagram representing a fabricating method in case that a neon cutting material is mixed with a dielectric layer;

FIGS. 6A and 6B are diagrams representing a neon cutting material; and

FIG. 7 is a diagram representing a fabricating method in case that a neon cutting material is mixed with a protection layer.

### DETAILED DESCRIPTION OF PREFERRED EMBODIMENTS

Preferred embodiments of the present invention will be described in a more detailed manner with reference to the drawings.

A plasma display panel according to an aspect of the present invention comprises an upper substrate and a lower substrate that are connected with a predetermined distance therebetween, and an upper dielectric layer comprising a optical characteristic improvement material that is formed on the upper substrate.

1% to 50% of the dielectric layer comprises the optical characteristic improvement material.

The optical characteristic improvement material is made of a neon cutting material.

The neon cutting material comprises at least one of phorpyrin dyes or squarylium dyes.

The dielectric layer comprises at least two of the following dielectric layer forming material; Pbo, SiO₂, B₂O₃, Al₂O₃, ZnO, BaO, CoO, or CuO.

The optical characteristic improvement material and a dielectric forming material of the upper dielectric layer are mixed in a slurry or a paste state and are fired to form a dielectric layer.

The plasma display panel further comprises a front filter, which is formed on the front surface of the upper substrate and includes at least one of an antireflection film, a glass, an EMI shielding film or a NIR shielding film.

A plasma display panel according to another aspect of the present invention comprises an upper substrate and a lower substrate that are connected with a predetermined distance therebetween, an upper dielectric layer formed on the upper substrate, and a protection film comprising a optical characteristic improvement material that is formed on the upper dielectric layer.

1 to 50% of the protection film comprises the optical characteristic improvement material.

The optical characteristic improvement material is made of a neon cutting material.

The neon cutting material comprises at least one of phorpyrin dyes or squarylium dyes.

The protection film comprises MgO.

The optical characteristic improvement material and a protection film forming material of the protection film are mixed in a slurry or a paste state and are fired to form a protection film.

The plasma display panel further comprises a front filter, which is formed on a front surface of the upper substrate and includes at least one of an antireflection film, a glass, an EMI shielding film or a NIR shielding film.

A plasma display panel according to still another aspect of the present invention comprises an upper substrate comprising a optical characteristic improvement material, and a low substrate connected with the upper substrate with a predetermined distance therebetween.

1 to 50% of the upper substrate comprises the optical characteristic improvement material.

The optical characteristic improvement material is made of a neon cutting material.

The neon cutting material comprises at least one of phorpyrin dyes or squarylium dyes.

The optical characteristic improvement material and a substrate forming material of the upper substrate are mixed in a slurry or a paste state and are fired to form an upper substrate. The plasma display panel further comprises a front filter which is formed on a front surface of the upper substrate and includes at least one of an antireflection film, a glass, an EMI shielding film or a NIR shielding film.

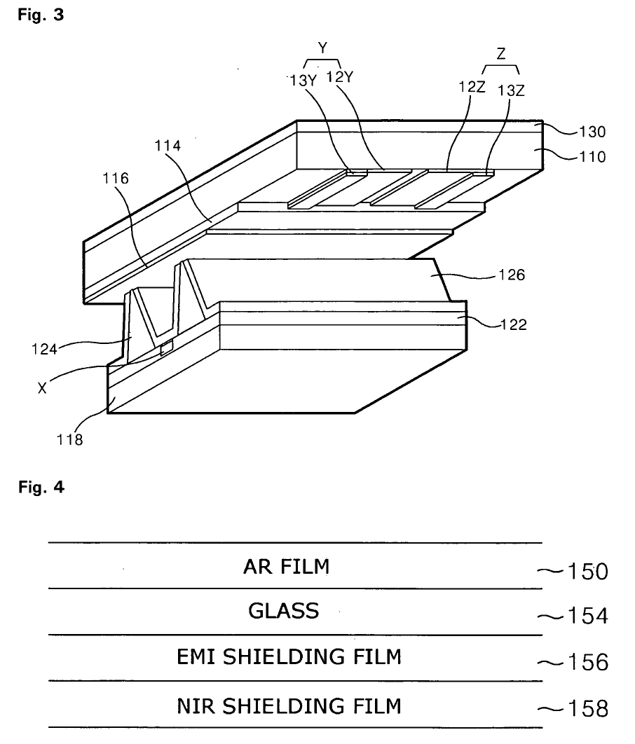

FIG. 3 is a perspective diagram representing a discharge of a plasma display panel according to an embodiment of the present invention.

Referring to FIG. 3, a discharge cell of a PDP of the present invention includes a scan electrode Y and a sustain electrode Z which are formed in an opposite surface of an upper substrate 110 to a lower substrate 118, a front filter 130 formed on the upper substrate 110, and an address electrode X formed in an opposite surface of the lower substrate 118 to the upper substrate 110. The scan electrode Y and the sustain electrode Z respectively include transparent electrodes 112Y, 112Z, and bus electrodes 113Y, 113Z formed at an edge of one side of the transparent electrode to have a narrower line width than the transparent electrodes 112Y, 112Z.

The transparent electrodes 112Y, 112Z are usually formed of indium tin oxide ITO on the upper substrate 110. The metal bus electrodes 113Y, 113Z are formed of a metal such as mainly chrome Cr, etc on the transparent electrodes 112Y, 112Z to act to reduce a voltage drop caused by the transparent electrodes 112Y, 112Z of which the resistance is high. An upper dielectric layer 114 and a protection layer 116 are deposited in the upper substrate 110 where the scan electrode Y and the sustain electrode Z are formed in parallel to each other. Wall charges generated upon plasma discharge are accumulated into the upper dielectric layer 114. The protection layer 116 prevents a damage of the upper dielectric layer 114 caused by a sputtering generated upon the plasma discharge and improves the emission efficiency of secondary electrons. The protection layer 116 is usually made of magnesium oxide MgO.

In the present invention like this, the upper dielectric layer 114, the protection layer 116 and/or the upper substrate 110 further includes an optical characteristic improvement material, i.e., neon, so that color purity can be improved. If such an optical characteristic improvement material is included in the upper dielectric layer 114, the protection layer 116 and/or the upper substrate 110, it is possible to remove an optical characteristic film from the front filter 130. Detailed description for this will be made later.

A lower dielectric layer 122 and barrier ribs 124 are formed on the lower substrate 118 where the address electrode X is formed, and a phosphorous layer 126 is coated on the surfaces of the lower dielectric layer 122 and the barrier ribs 124. The address electrode X is formed in a direction of crossing the scan electrode Y and the sustain electrode Z. The barrier rib 124 is formed in a stripe or lattice shape to prevent an ultraviolet ray and a visible ray generated by a discharge from being leaked to the adjacent cells. The phosphorous layer 126 is excited by an ultraviolet ray generated upon the plasma discharge to generate any one of red, green and blue visible rays. An inert mixture gas is injected into a discharge space provided between the upper and lower substrates 110 and 118 and the barrier ribs 124.

The front filter 130 intercepts electromagnetic wave and prevents reflection of external light. An optical characteristic film is not included in the front filter 130 of the present invention.

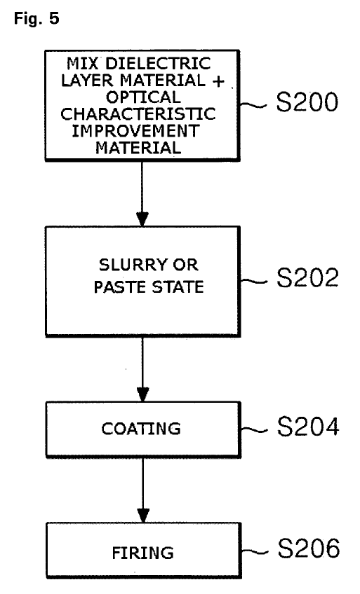

FIG. 4 is a cross sectional diagram representing a front filter shown in FIG. 3 according to an embodiment of the present invention.

Referring to FIG. 4, the front filter 130 includes an antireflection film 150, a glass 154, an EMI shielding film 156 and a NIR shielding film 158. And, in the present invention, an adhesive layer (not shown) is further formed in between the films 150, 154, 156, and 158 of each front filter 130.

The antireflection film 150 is formed on the surface of the front filter 130 and prevents a light, which is incident to the PDP from the outside, from being reflected. That is to say, the antireflection film 150 prevents the incident light from the outside from being emitted again to the outside of the PDP, thereby improving contrast.

The glass 154 prevents the front filter 130 from being damaged by external impacts. In other words, the glass 154 supports the front filter 130 in order to prevent the front filter 130 from being damaged by external impacts. Herein, the glass 154 might not be included in the front filter 130.

The EMI shielding film 156 intercepts EMI, and prevents the incident EMI from the PDP from being emitted to the outside.

The NIR shielding film 158 intercepts NIR which is emitted from the PDP to the outside, and the NIR shielding film 158 prevents an excessive emission of NIR to the outside so that the signals supplied to the PDP from a remote controller, etc can be normally transmitted.

The optical characteristic film is not included in the front filter 130 of the present invention. If the optical characteristic film is not included in the front filter 130, the PDP can be made thinner than the related art. And, if the optical characteristic film is not included in the front filter 130, its manufacturing cost is reduced and its process time can be shortened.

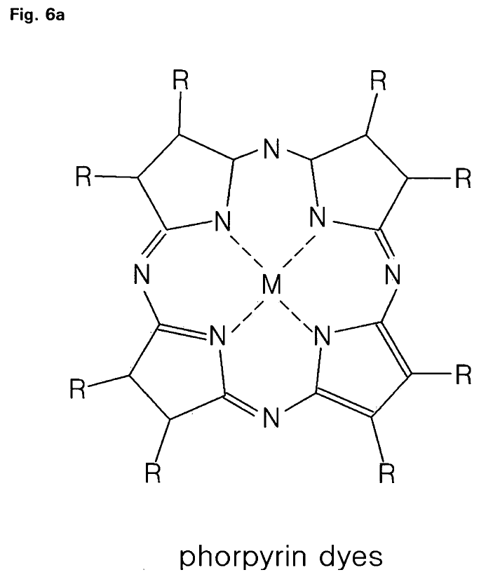

FIG. 5 is a diagram representing a fabricating method of an upper dielectric layer when an optical characteristic improvement material is included in the upper dielectric layer.

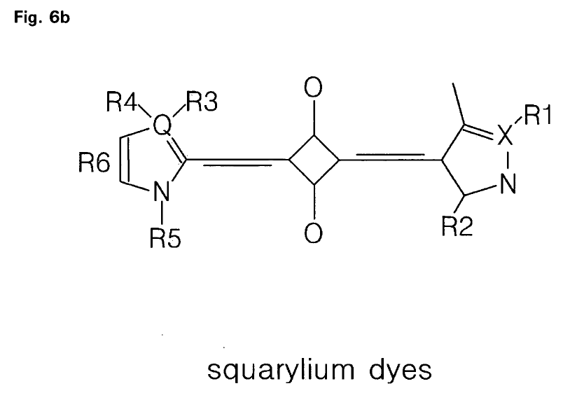

Referring to FIG. 5, firstly, a dielectric layer material is mixed with a neon cutting material which is the optical characteristic improvement material. (S200) The dielectric layer material is composed by mixing at least two of PbO, SiO2, B2O3, Al2O3, ZnO, BaO, CoO or CuO. At least one of porphyrin dye or squarylium dye is selected as the neon cutting material, as shown in FIGS. 6A and 6B. In reality, the neon cutting material is added to the dielectric layer material at 1% to 50% in the step S200. After then, for the convenience of explanation, the mixture of the dielectric layer material and the neon cutting material will be named as a first mixture material.

The first mixture material generated in the step S200 is changed to a slurry or paste state so that it can be coated on the upper substrate 110. (S202) To this end, a designated solvent is added to the first mixture material in the step S202. Herein, a known solution used when changing the dielectric layer forming material to the slurry or paste state can be selected as the solvent used in the step S202.

The first mixture material changed to the slurry or paste state in the step S202 is coated on the upper substrate 110. (S204) And, the first mixture material is fired at a designated temperature to form the upper dielectric layer 114. (S206)

The upper dielectric layer 114 formed in this way performs a role of the dielectric layer and a role of the optical characteristic film at the same time. In other words, a designated wall charge is formed in the upper dielectric layer 114 by discharge. And the upper dielectric layer 114 partially absorbs a light of yellow wavelength generated by the discharge, thereby improving a color purity of red light.

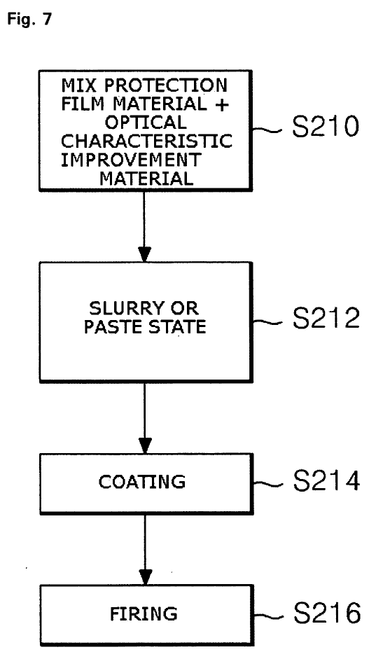

FIG. 7 is a diagram representing a fabricating method of a protection layer when the optical characteristic improvement material is included in the protection layer.

Referring to FIG. 7, firstly, a protection layer forming material is mixed with a neon cutting material which is the optical characteristic improvement material. (S210) A material including MgO is generally selected as the protection layer forming material. At least one of porphyrin dye or squarylium dye is selected at the neon cutting material, as shown in FIGS. 6A and 6B. In reality, the neon cutting material is added to the dielectric layer material at 1% to 50% in the step S210. After then, for the convenience of explanation, the mixture of the dielectric layer material and the neon cutting material will be named as a second mixture material.

The second mixture material generated in the step S210 is changed to a slurry or paste state so that it can be coated on the upper substrate 110. (S212) To this end, a designated solvent is added to the second mixture material in the step S212. Herein, a known solution used when changing the protection layer forming material to the slurry or paste state can be selected as the solvent used in the step S212.

The second mixture material changed to the slurry or paste state in the step S212 is coated on the upper substrate 110. (S214) And, the second mixture material is fired at a designated temperature to form the protection layer 116. (S216)

The protection layer 116 protects the upper dielectric layer 114, and at the same time, partially absorbs a light of yellow wavelength, thereby improving a color purity of red light.

On the other hand, in the present invention, the optical characteristic improvement material can be comprised in the upper substrate 130. In this case, neon is added to the upper substrate forming material at 1% to 50%, thereby forming the upper substrate 130. Then, the upper substrate 130 partially absorbs a light of yellow wavelength emitted the outside from the panel, thereby improving a color purity of red light.

As described above, the plasma display panel according to the embodiment of the present invention forms the upper dielectric layer, the protection layer or the upper substrate so that the neon cutting material is included therein. Then, the upper dielectric layer, the protection layer or the upper substrate including the neon cutting material partially absorbs a light of yellow wavelength which is emitted to the outside from the panel, thereby improving the color purity of red light. Further, the present invention can remove the optical characteristic film from the front filter, and the panel can be made thin and the manufacturing cost can be reduced accordingly.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A plasma display panel comprising:
an upper substrate and a lower substrate that are connected with a predetermined distance therebetween; and
an upper dielectric layer comprising a optical characteristic improvement material that is formed on the upper substrate.

2. The plasma display panel of claim 1, wherein 1% to 50% of the dielectric layer comprises the optical characteristic improvement material.

3. The plasma display panel of claim 1, wherein the optical characteristic improvement material is made of a neon cutting material.

4. The plasma display panel of claim 3, wherein the neon cutting material comprises at least one of phorpyrin dyes or squarylium dyes.

5. The plasma display panel of claim 1, wherein the dielectric layer comprises at least two of the following dielectric layer forming material; Pbo, SiO₂, B₂O₃, Al₂O₃, ZnO, BaO, CoO, or CuO.

6. The plasma display panel of claim 1, wherein the optical characteristic improvement material and a dielectric forming material of the upper dielectric layer are mixed in a slurry or a paste state and are fired to form a dielectric layer.

7. The plasma display panel of claim 1, further comprising a front filter, which is formed on the front surface of the upper substrate and includes at least one of an antireflection film, a glass, an EMI shielding film or a NIR shielding film.

8. A plasma display panel comprising:
an upper substrate and a lower substrate that are connected with a predetermined distance therebetween;
an upper dielectric layer formed on the upper substrate; and
a protection film comprising a optical characteristic improvement material that is formed on the upper dielectric layer.

9. The plasma display panel of claim 8, wherein 1 to 50% of the protection film comprises the optical characteristic improvement material.

10. The plasma display panel of claim 8, wherein the optical characteristic improvement material is made of a neon cutting material.

11. The plasma display panel of claim 10, wherein the neon cutting material comprises at least one of phorpyrin dyes or squarylium dyes.

12. The plasma display panel of claim 8, wherein the protection film comprises MgO.

13. The plasma display panel of claim 8, wherein the optical characteristic improvement material and a protection film forming material of the protection film are mixed in a slurry or a paste state and are fired to form a protection film.

14. The plasma display panel of claim 8, further comprising a front filter, which is formed on a front surface of the upper substrate and includes at least one of an antireflection film, a glass, an EMI shielding film or a NIR shielding film.

15. A plasma display panel comprising:
an upper substrate comprising a optical characteristic improvement material; and
a low substrate connected with the upper substrate with a predetermined distance therebetween.

16. The plasma display panel of claim 15, wherein 1 to 50% of the upper substrate comprises the optical characteristic improvement material.

17. The plasma display panel of claim 15, wherein the optical characteristic improvement material is made of a neon cutting material.

18. The plasma display panel of claim 17, wherein the neon cutting material comprises at least one of phorpyrin dyes or squarylium dyes.

19. The plasma display panel of claim 15, wherein the optical characteristic improvement material and a substrate forming material of the upper substrate are mixed in a slurry or a paste state and are fired to form an upper substrate.

20. The plasma display panel of claim 15, further comprising a front filter which is formed on a front surface of the upper substrate and includes at least one of an antireflection film, a glass, an EMI shielding film or a NIR shielding film.
